(19) United States
(12) Patent Application Publication
(10) Pub. No.: US 2004/0036927 A1
(43) Pub. Date: Feb. 26, 2004

(54) Lamp assembly of scanning apparatus

(76) Inventor: Yi-Ting Chen, Tao Yuan Hsien (TW)

Correspondence Address: Morton J. Rosenberg, Esq., Rosenberg, Klein & Lee, Suite 101, 3458 Ellicott Center Drive, Ellicott City, MD, 21043, US

(21) Appl. No.: 10/224,645

(22) Filed: Aug. 21, 2002

(51) Int. Cl. H04N 1/04; H04N 1/46

(52) U.S. Cl. 358/474; 358/509

(57) ABSTRACT

A lamp assembly of scanning apparatus comprises a CCF lamp, a light-guiding mask and a heating element. The light-guiding mask is mounted onto the CCF lamp to reflect the light there from along a space defined within the light-guiding mask. The light propagating within this space of the light-guiding mask thereby has more uniform and higher brightness. The heating element further warms up the light-guiding mask to control the temperature at the periphery of the CCF lamp. The warming time of the CCF lamp is thereby reduced to attain a full brightness. The utilization of the lamp assembly is therefore more efficient.

### BACKGROUND OF THE INVENTION

1. Field of the Invention

The invention relates to a lamp assembly of scanning apparatus. More particularly, the invention provides a lamp assembly in which a light-guiding mask and a heating element are mounted outside the CCF lamp to reduce the time needed by the CCF lamp to attain a uniform, full and stable brightness.

2. Description of the prior Art

As computer equipment generally are increasingly cheaper, scanning apparatuses particularly become more popular. A scanning apparatus typically converts a text or graphic document to an electronic image format readable by a computer. This image format then can be processed as desired within the computer. To improve the image quality provided by the scanning apparatus, the light brightness and stability of the lamp of the scanning apparatus play an important role.

FIG. 1 is a schematic view illustrating a conventional lamp device of a scanning apparatus. The lamp device traditionally comprises a cold cathode fluorescent (CCF) lamp 10a from which is emitted a light to scan the document (not shown). Two terminals of the CCF lamp 10a respectively engage within rubber sleeves 20a to protect the electrical connection portions of the CCF lamp 10a with the electrical wire 30a and further mount the CCF lamp 10a within the scanning apparatus (not shown).

However, the above traditional lamp device has the following inconveniences:

1. the brightness of the light emitted from the CCF lamp 10a along the scanning of the document is not sufficient;

2. the CCF lamp 10a has regions of weaker light intensity and regions of stronger light intensity, which causes a nonuniform brightness; and

3. the necessary warming time of the CCF lamp is excessively long to attain a full brightness.

### SUMMARY OF THE INVENTION

It is therefore a principal object of the invention to provide a lamp assembly of scanning apparatus that uses the mount of a light-guiding mask to reflect the light from the CCF lamp along a space defined within the light-guiding mask so as to increase the brightness along that direction.

It is another object of the invention to provide a lamp assembly of scanning apparatus that uses the mount of a light-guiding mask to reflect the light from the CCF lamp so as to compensate the lights from different regions of weaker and stronger light intensity, thereby achieving a more uniform brightness.

Yet, it is another object of the invention to provide a lamp assembly of scanning apparatus that uses the mount of a heating element to control the temperature at the periphery of the CCF lamp. The warming time of the CCF lamp is thereby reduced and a full and stable brightness can be rapidly achieved. The scanning apparatus can thereby normally operates even in a low temperature condition.

To accomplish the above and other objectives, a lamp assembly of scanning apparatus of the invention comprises a CCF lamp, a light-guiding mask and a heating element. The light-guiding mask is mounted below the CCF lamp to direct the propagation of the light from the CCF lamp along a space within the light-guiding mask by reflection. The light brightness along this space is thereby doubly increased and more uniform. The heating element is mounted onto the light-guiding mask to warm up the light-guiding mask. As a result, the temperature at the periphery of the CCF lamp is controlled to reduce the time needed by the CCF lamp to attain its full brightness.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a perspective view schematically illustrating a conventional lamp device of scanning apparatus;

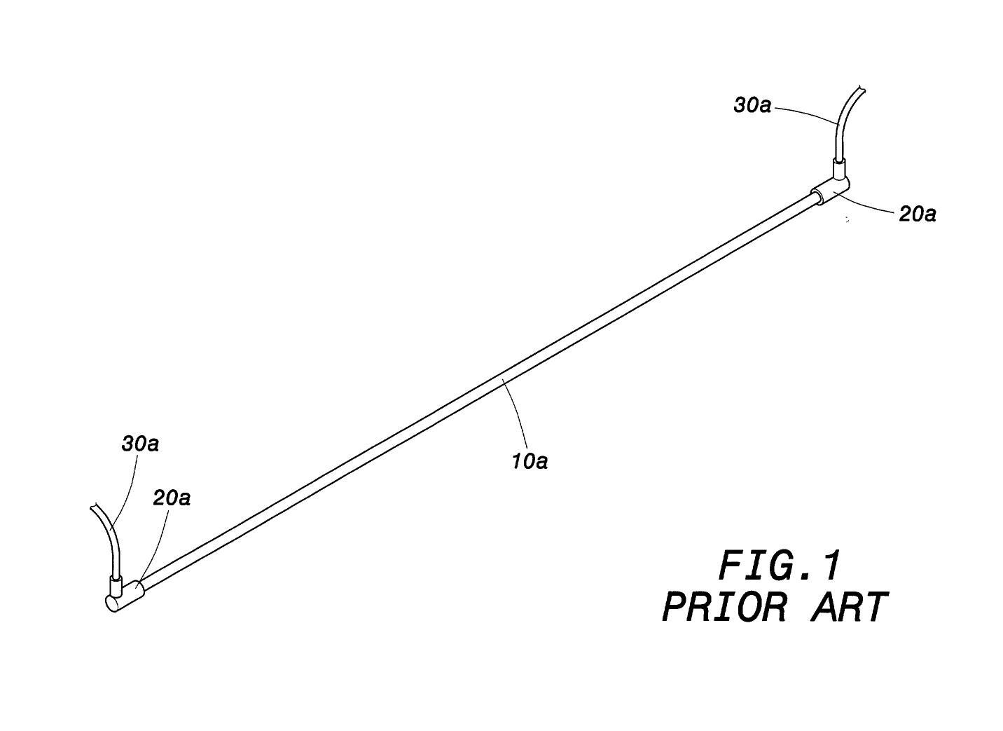

FIG. 2 is an exploded view schematically illustrating a lamp assembly of scanning apparatus according to an embodiment of the invention;

FIG. 3 is a local longitudinally sectional view of a lamp assembly according to an embodiment of the invention;

FIG. 4 is a perspective view of a lamp assembly of scanning apparatus according to an embodiment of the invention;

FIG. 5 is a radially sectional view of a lamp assembly of scanning apparatus according to an embodiment of the invention;

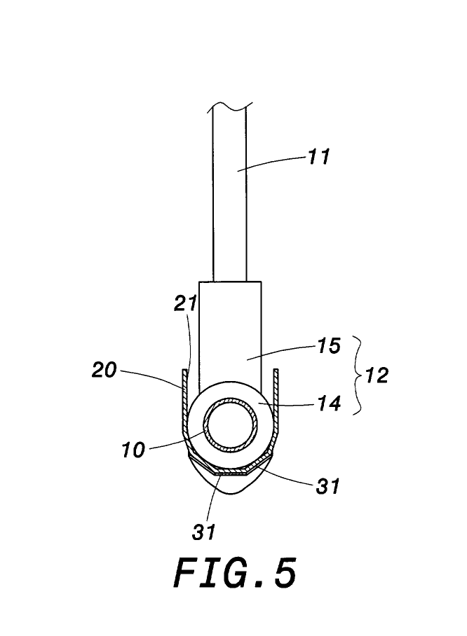

FIG. 6 is a perspective view schematically illustrating a lamp assembly of scanning apparatus according to another embodiment of the invention; and

FIG. 7 is an exploded view of a lamp assembly of scanning apparatus according to another embodiment of the invention.

### DETAILED DESCRIPTION OF THE EMBODIMENTS

Wherever possible in the following description, like reference numerals will refer to like elements and parts unless otherwise illustrated.

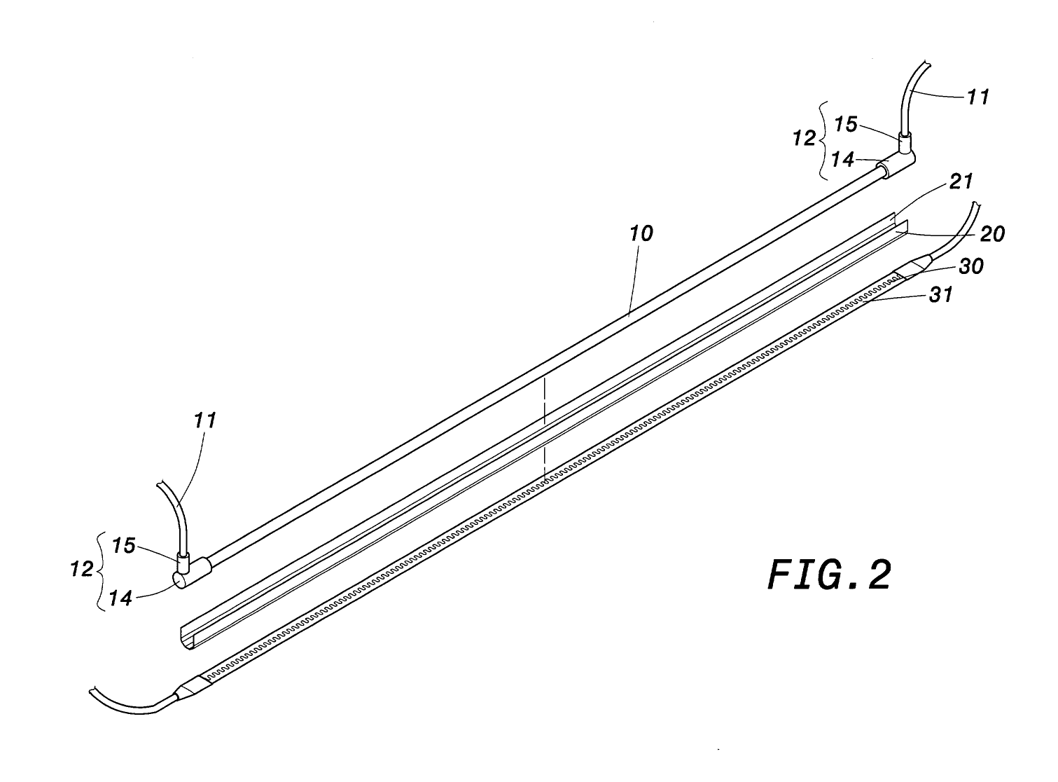

Referring to FIG. 2, a lamp assembly of scanning apparatus according to the invention comprises a cold cathode fluorescent (CCF) lamp 10, a light-guiding mask 20 and a heating resistor 30. The heating resistor 30 is mounted on the light-guiding mask 20 to heat the light-guiding mask 20. The light-guiding mask 20 is mounted to the CCF lamp 10 to reflect a light emitted there from. The light from the CCF lamp 10 is used within a scanning apparatus to scan documents.

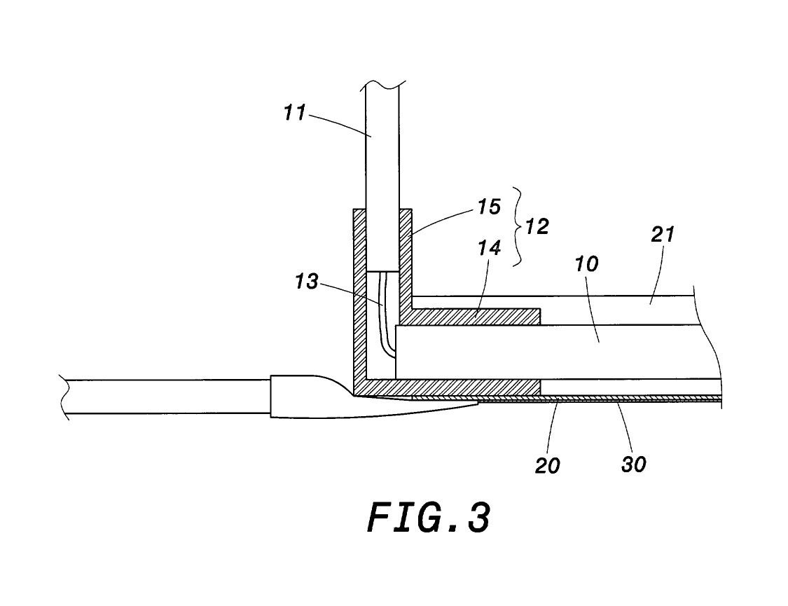

Referring to FIG. 2 and FIG. 3, two terminals of the CCF lamp 10 are electrically connected to an electrical wire 11. Insulating sleeves 12 made of, for example, rubber, respectively enclose electrical connection portions 13 between the CCF lamp 10 and the electrical wire 11 for protection purpose. The insulating sleeves 12 are formed in a single body that is composed of a large hollow envelope 14 and a small hollow envelope 15. An opening of the large hollow envelope 14 engages with a terminal portion of the CCF lamp 10 while another opening of the large hollow envelope 14 is sealed. An opening of the small hollow envelope 15 engages with a terminal portion of the electrical wire 11. Another terminal portion of the small hollow envelope 15 connects with the large hollow envelope 14 in such a manner that both envelopes 14, 15 are approximately perpendicular to each other.

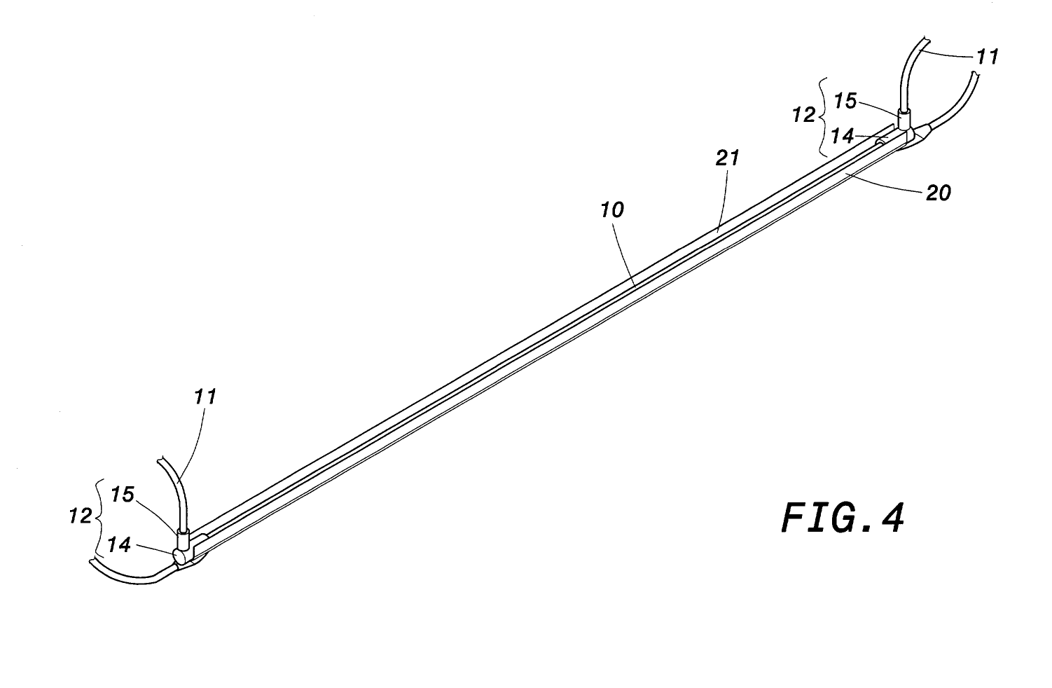

Referring to FIG. 2 and FIG. 4, the light-guiding mask 20 is formed from an aluminum sheet bent in U-shape at the arcuate bottom of which is mounted the CCF lamp 10. The U-shaped light-guiding mask 20 extends in two plates at two sides of the CCF lamp 10, the two plates internally exhibiting respective reflective faces 21. The arcuate bottom of the light-guiding mask 20 and the two plates thereto connected reflect the light from the CCF lamp 10 according to a propagation along the space between the two plates. The light from the CCF lamp 10 is thereby prevented from propagating along other directions (not shown). The light brightness along the space between the two plates of the light-guiding mask 20 is thereby typically doubled in comparison with that of the prior art. The light emitted from the CCF lamp 10 and reflected via the light-guiding mask 20 can further compensate the lights from the regions of weaker light intensity and the regions of stronger light intensity. The difference of light intensity between the different regions of the CCF lamp 10 is thereby attenuated. Furthermore, the light intensity along the space in the light-guiding mask 20 is more uniform.

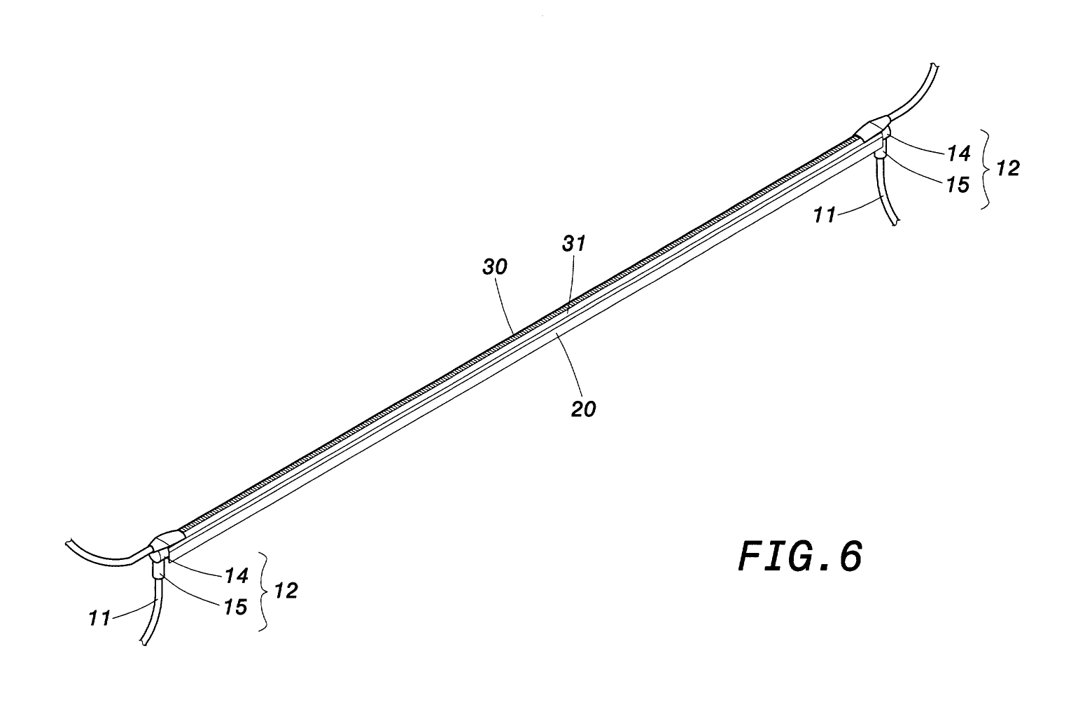

Referring to FIG. 2 and FIG. 6, because the temperature at the periphery of the CCF lamp 10 is relatively low, a warming time of the CCF lamp 10 traditionally is excessively long. To reduce the warming time, the heating resistor 30 is mounted onto the light-guiding mask 20 to control the temperature at the periphery of the CCF lamp 10. The heating resistor 30 is bent in a long rod shape. Through the contact surface of the heating resistor 30, the heat is transmitted to the light-guiding mask 20 so as to control the temperature at the periphery of the CCF lamp 10. As a result, the warming time of the CCF lamp 10 is reduced to attain a full and stable brightness. Furthermore, the adhesive tape 31 is attached onto the light-guiding mask 20 to squeeze the heating resistor 30 against the light-guiding mask 20. The contact of the heating resistor 30 with the light-guiding mask 20 is thereby easily ensured, and a protection of the heating resistor 30 is further effectively achieved.

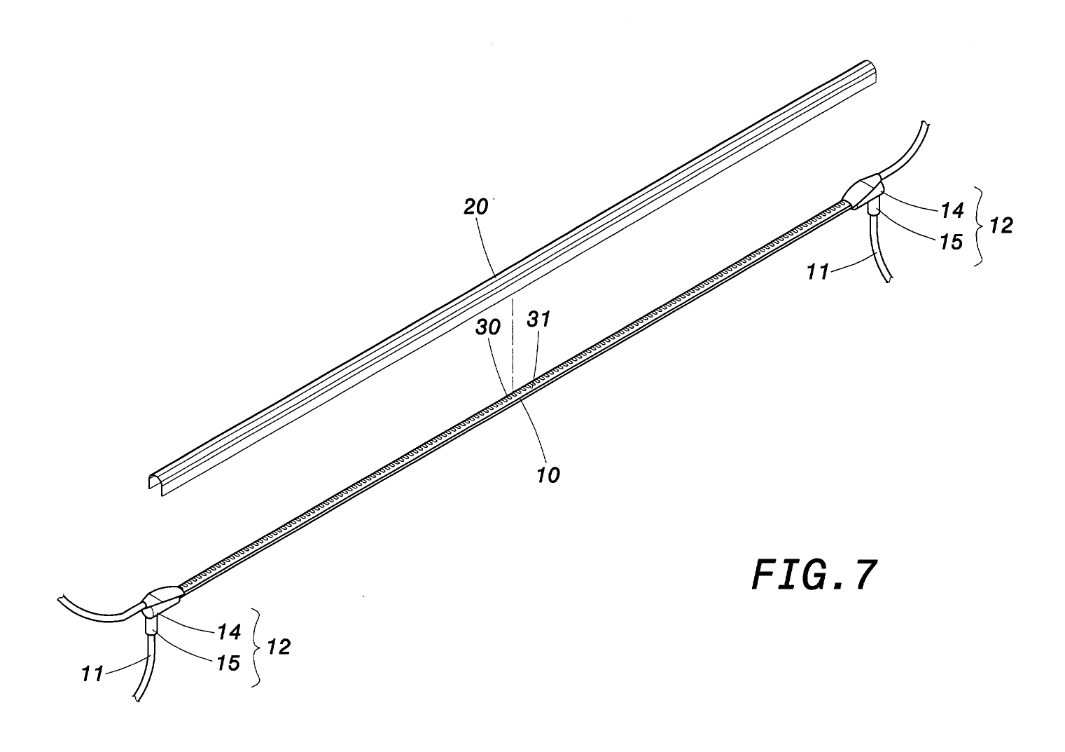

Referring to FIG. 7, the heating resistor 30 alternatively can be directly mounted onto the CCF lamp 10 to directly warm up the CCF lamp 10 within a shorter warming time. The adhesive tape 31 is further attached on an outer side of the heating resistor 30 and CCF lamp 10 in a manner to squeeze the heating resistor 30 between the adhesive tape 31 and the light-guiding mask 20. Finally, the light-guiding mask 20 is mounted at an outer side of the heating resistor 30 and CCF lamp 10.

As described above, the invention therefore provides a lamp assembly of scanning apparatus that uses a light-guiding mask to reflect the light from the CCF lamp along a space defined between within the light-guiding mask. The brightness along this space is thereby doubled and more uniform. By further mounting a heating resistor to warm up the light-guiding mask, the temperature at the periphery of the CCF lamp can be controlled. As a result, the warming time of the CCF lamp is reduced, and a full brightness at a stable level is rapidly achieved.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A lamp assembly of scanning apparatus, comprising:
a cold cathode fluorescent (CCF) lamp;
a light-guiding mask, mounted onto the CCF lamp; and
a heating element, attached onto the light-guiding mask for warming up the light-guiding mask.

2. The lamp assembly of claim 1, further including an adhesive tape attached to the heating element for arranging the heating element between the light-guiding mask and the adhesive tape.

3. The lamp assembly of claim 1, wherein the light-guiding mask is formed from a bent aluminum sheet.

4. The lamp assembly of claim 1, wherein the light-guiding mask is bent in a U-shape.

5. The lamp assembly of claim 1, further-including at least one reflective face placed on the light-guiding mask which is adjacent to the CCF lamp.

6. The lamp assembly of claim 1, wherein the heating element is a heating resistor.

7. The lamp assembly of claim 6, wherein the heating resistor is bent in a rod shape.

8. A lamp assembly of scanning apparatus, comprising:
a cold cathode fluorescent (CCF) lamp; and
a heating element, attached onto the CCF lamp for warming up the CCF lamp.

9. The lamp assembly of claim 8, further including a light-guiding mask mounted onto an outer side of the CCF lamp and heating element.

10. The lamp assembly of claim 9, further including at least one reflective face placed on the light-guiding mask which is adjacent to the CCF lamp.

11. The lamp assembly of claim 9, wherein the light-guiding mask is formed from a bent aluminum sheet.

12. The lamp assembly of claim 9, wherein the light-guiding mask is bent in a U-shape.

13. The lamp assembly of claim 8, further including an adhesive tape attached onto the heating element and the CCF lamp in a manner to have the heating element arranged between the adhesive tape and the CCF lamp.

14. The lamp assembly of claim 8, wherein the heating element is a heating resistor.

15. The lamp assembly of claim 14, wherein the heating resistor is bent in a rod shape.
